(19) United States
(12) Patent Application Publication
(10) Pub. No.: US 2010/0071785 A1
(43) Pub. Date: Mar. 25, 2010

(54) Fuel cutoff valve

(75) Inventors: Natsushi Miura, Aichi-ken (JP); Norihiro Yamada, Aichi-ken (JP); Masanori Nojiri, Aichi-Ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-Ken (JP)

(21) Appl. No.: 12/585,412

(22) Filed: Sep. 15, 2009

(30) Foreign Application Priority Data
Sep. 19, 2008 (JP) 2008-240806

(51) Int. Cl. F16K 31/18

(52) U.S. Cl. 137/429

(57) ABSTRACT

The fuel cutoff valve has a casing that defines a casing body having a valve chamber and a communicating chamber that connects the valve chamber to the outside; and a float mechanism that is housed within the valve chamber and adapted to open and close a connecting passage through rise and fall in accordance with the fuel level inside the fuel tank. The casing has projecting out respectively from its side part a first pipe that connects to the communicating chamber as well as connecting to the outside via a tube, and a second pipe that connects the communicating chamber to another valve via a tube. The first pipe and the second pipe are situated in a mutually parallel arrangement in the vertical direction.

This application claims the benefit of and priority from Japanese Application No. 2008-240806 filed Sep. 19, 2008, the content of which is incorporated herein by reference.

### BACKGROUND OF THE INVENTION

1. Field of the Invention

The present invention relates to a fuel cutoff valve that is mounted on an upper wall of a fuel tank and opens and closes of a connecting passage that connects the fuel tank interior with outside.

2. Description of the Related Art

A fuel tank system employing the fuel cutoff valve is described in JP-A 1-301227. In the system, the several fuel cutoff valves for connecting the fuel tank interior with the canister are disposed on the upper wall of the fuel tank, thereby ensuring venting to the outside even if the fuel tank should tilt in association with pitching of the vehicle. According to the above fuel cutoff valve design, in order to simplify routing of the line that leads to the canister there is employed an arrangement in which the projecting pipe that connects one fuel cutoff valve to another fuel cutoff valve is provided separately from the pipe that leads to the canister. FIG. 6 is a plane view showing a conventional fuel cutoff valve viewed from above. Pipe portions 104, 106 project from a cover 102 provided at the top of the fuel cutoff valve 100. The pipe portions 104, 106 are situated at 180° intervals centered on the cover 102, and respectively connect via tubes T1, T2 to the canister and to another fuel cutoff valve.

However, as the pipe portions 104, 106 of the fuel cutoff valve, inclusive of the tube T1, T2 layout, require considerable space around the upper portion of the fuel cutoff valve, particularly where the fuel cutoff valve is installed inside of the tank, the result may be that it is difficult to ensure sufficient installation space for the fuel cutoff valve.

### SUMMARY

An advantage of some aspects of the invention is to provide a fuel cutoff valve whereby the layout of tubes within the fuel tank may be accomplished within a constricted space.

The present invention is addressed to attaining the above objects at least in part according to the following modes of the invention.

According to an aspect of the invention, a fuel cutoff valve is provided that is mounted on an upper wall of a fuel tank and opens and closes of a connecting passage that connects the fuel tank interior with outside. The fuel cutoff valve comprises a casing that includes a casing body having a valve chamber that connects to the connecting passage, and a communicating chamber that connects the valve chamber to the outside; and a float mechanism that is housed within the valve chamber and adapted to open and close the connecting passage through rise and fall in accordance with a fuel level inside the fuel tank. The casing has a first pipe that projects from a side part of the casing and connects a communicating chamber with the outside via a tube, and a second pipe that projects from a side part of the casing and connects the communicating chamber with another valve situated in the fuel tank via a tube. The first pipe and the second pipe are situated in a mutually parallel arrangement in the vertical direction.

A fuel tank employing the fuel cutoff valve according to this first mode of the invention connects to the outside through the valve chamber of the fuel cutoff valve, the connecting passage, the first pipe, and then through the tube so that venting may be assured. If, due to pitch or rocking of the vehicle, the fuel level in the fuel tank should then reach a certain prescribed level, fuel will flow into the valve chamber. The float mechanism will thereby rise through buoyancy, and the float mechanism will close off the communicating passage so that fuel does not leak out towards the canister. The other valve provided inside the fuel tank is connected via a tube to the second pipe, and from the communicating chamber thence communicates with the outside through the first pipe part. In this way, the fuel cutoff valve also functions as a vent passage to the outside for the other valve.

In this first mode, since the first and second pipes are situated at the same location in the circumferential direction of the casing and line up in the vertical direction, that is, they are clustered together in a space to one side of the casing, the tubes which are connected to them will likewise be centralized, thus requiring less space inside the tank as compared with the case where they are arranged in spaces in more than one direction of the fuel cutoff valve as described in the Background Art. Moreover, by situating the first and second pipes to one side of the casing, an outside passage from the fuel tank can be led out from a single location without having to bend the tubes, thus simplifying the layout.

Additionally, according to this first mode, since the first and second pipes are situated at the same location in the circumferential direction of the casing and line up in the vertical direction, during the injection molding process the first and second pipes can be produced with a single-direction (namely horizontal) split mold, thus obviating the need for a mold design that requires slide molds from several directions, so manufacture will be simpler as well.

In a second mode, the communicating chamber is defined through enclosure by a passage-defining wall that constitutes the side part of the casing and that is separated from the valve chamber by the casing body.

These and other objects, features, aspects, and advantages of the to present invention will become more apparent from the following detailed description of the preferred embodiments with the accompanying drawings.

### BRIEF DESCRIPTION OF THE DRAWINGS

FIG. 1 is a sectional view showing a fuel tank of an automobile is wherein fuel cutoff valves according to one embodiment of the present invention are installed in the tank valve unit;

FIG. 2 is a perspective view showing a support structure of the tank valve unit;

FIG. 3 is a sectional view depicting the fuel cutoff valve housed within a housing part;

FIG. 4 is a side view showing the fuel cutoff valve;

FIG. 5 is an exploded sectional view of the fuel cutoff valve; and

FIG. 6 is a plane view showing a conventional fuel cutoff valve viewed from above.

### DESCRIPTION OF THE PREFERRED EMBODIMENTS

### (1) General Configuration of Mounting Structure for Tank Valve Unit

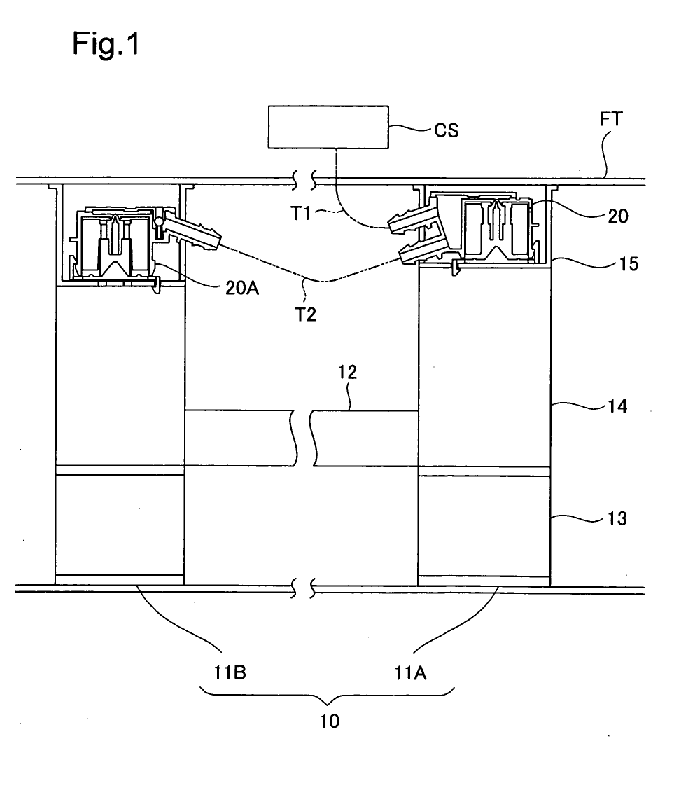

FIG. 1 is a sectional view showing a fuel tank FT of an automobile wherein fuel cutoff valves according to one embodiment of the present invention are installed in the tank valve unit. The fuel tank FT is formed by several laminated layers of resin material, and has been manufactured by a known method, namely, extrusion of a cylindrical parison into a die. A support body 10 and fuel cutoff valves 20, 20A have been disposed inside the fuel tank FT. The support body 10 is a component that is adapted to receive respective installation of the fuel cutoff valves 20, 20A; it also serves to enhance the fuel tank support structure and to reduce fuel surges. The fuel cutoff valves 20, 20A are valves of so-called inner tank design adapted to restrict fuel from spilling to the outside when the fuel level in the fuel tank FT rises as a result of tilt-over or veering of the vehicle for example; these are situated at multiple locations (two are shown) inside the fuel tank FT. The fuel cutoff valve 20 connects directly to a canister CN via a tube T1, while the fuel cutoff valve 20A connects to the canister CN via a tube T2 and the fuel cutoff valve 20. The other fuel cutoff valve 20 has two ports for connection to the canister CS and to the other fuel cutoff valve 20A, and is somewhat different in design from the fuel cutoff valve 20A, which has only one port.

### (2) Design of Support Body 10

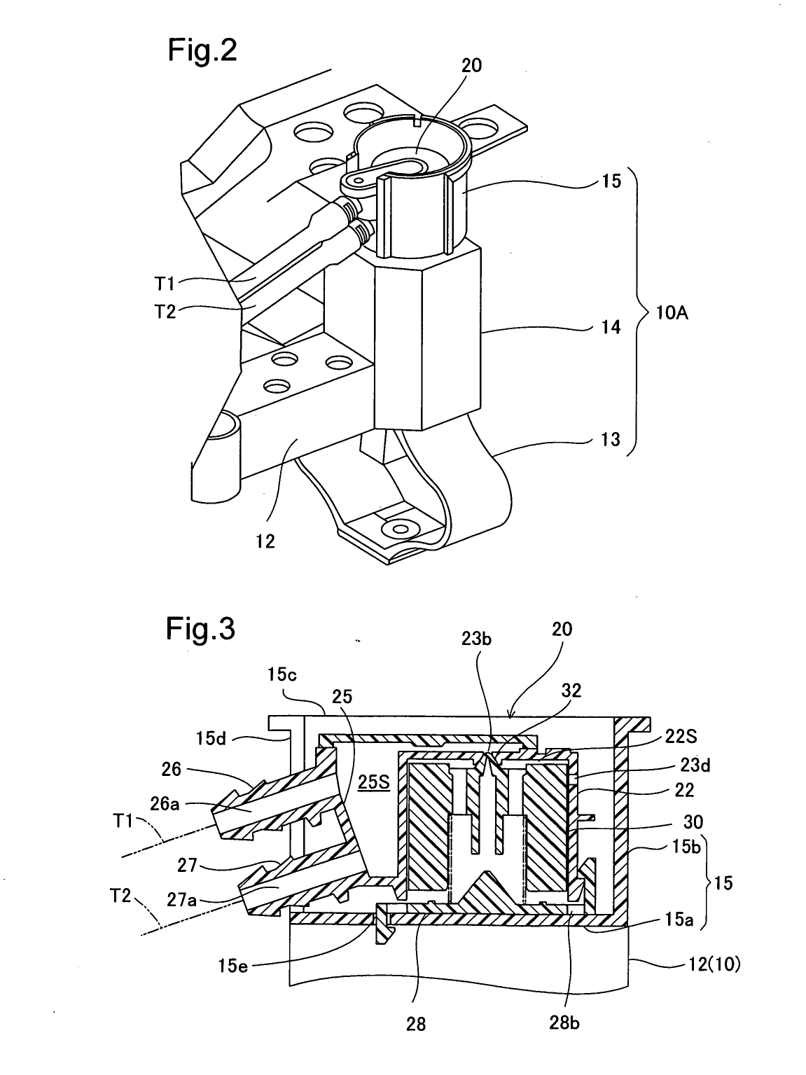

The support body 10 is composed of two support structures 11A, 11B; and a linking member 12 that links these support structures 11A, 11B. The support structures 11A, 11B are of substantially identical structure having the fuel cutoff valves 20, 20A installed respectively thereon. FIG. 2 is a perspective view showing the support structure 11A of the tank valve unit. The support structure 11A includes a damper part 13 that has been welded to the bottom wall of the fuel tank; a support post 14 that has been formed above the damper part 13; and a housing part 15 formed above the support post 14 and adapted to house the fuel cutoff valve 20. The damper part 13 functions to absorb expansion and contraction of the fuel tank, as well as damping transmission of vibration of the fuel tank to the fuel cutoff valve 20.

FIG. 3 is a sectional view depicting the fuel cutoff valve 20 housed within the housing part 15. The housing part 15 is a component of tubular shape designed to secure the fuel cutoff valve 20 and to cover the periphery of the fuel cutoff valve 20, thus preventing the fuel cutoff valve 20 from being affected by fuel surges; it includes a mounting plate 15a and a side wall 15b that projects upward with a tubular profile from the outside peripheral part of the mounting plate 15a, and is open at the top through an upper opening 15c, while opening to the side through a side opening 15d that has been formed in the side wall 15b.

### (3) Design of Fuel Cutoff Valve 20

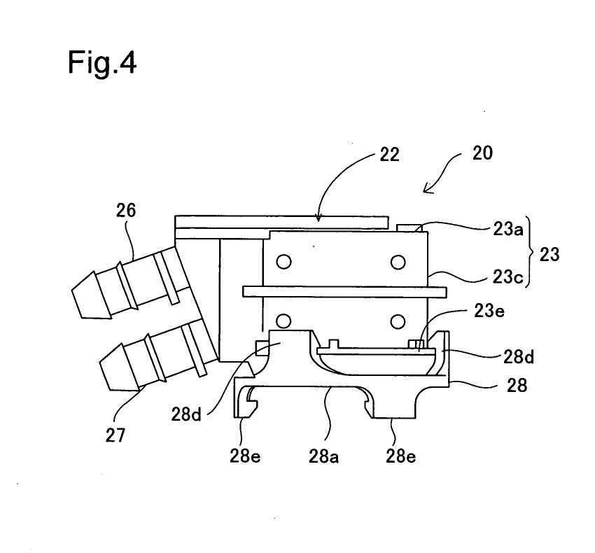

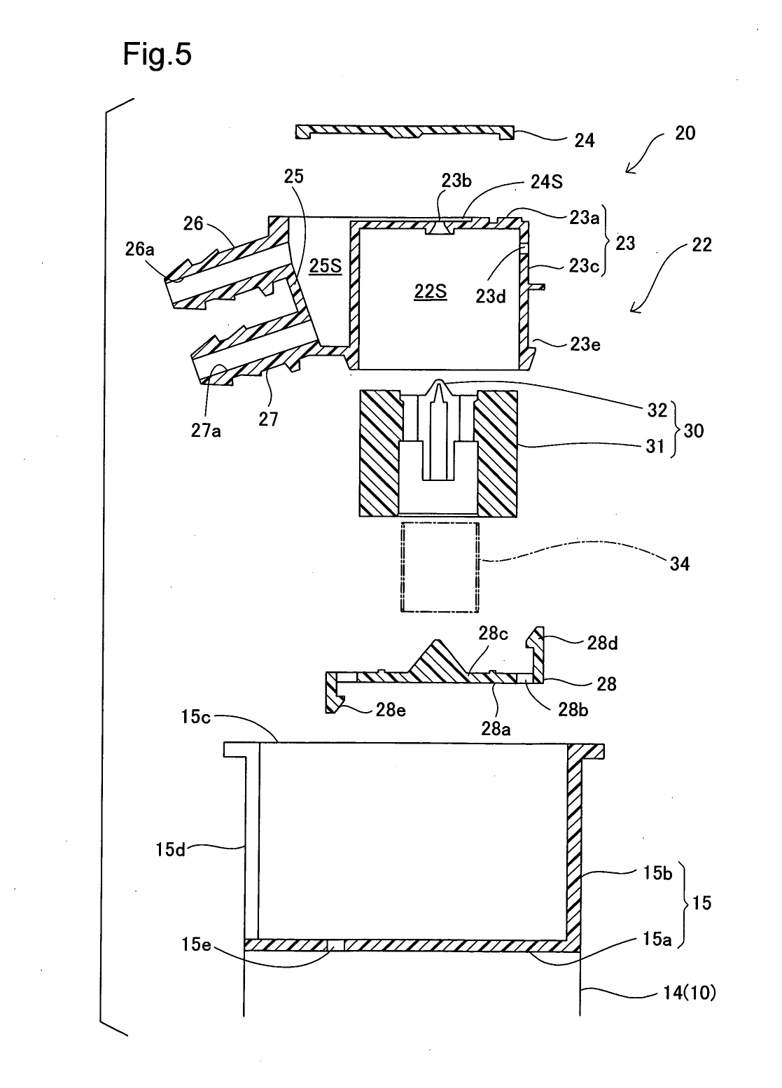

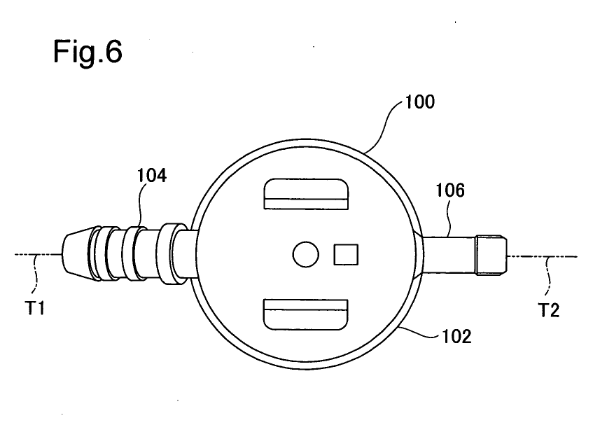

FIG. 4 is a side view showing the fuel cutoff valve 20; and FIG. 5 is an exploded sectional view of the fuel cutoff valve 20. The fuel cutoff valve 20 in FIG. 5 has as its principal constituents a casing 22, a float mechanism 30, and a spring 34. The casing 22 includes a casing body 23 of tubular shape; an upper cover 24 attached to the top of the casing body 23 and defining an upper chamber 24S above the casing body 23; and a base cover 28 attached to the bottom of the casing body 23, with the casing body 23 and the base cover 28 together defining a valve chamber 22S. In the center part of the upper wall 23a of the casing body 23 there is formed a connecting passage 23b; and a vent hole 23d is formed in the side wall 23c thereof. A communicating passage 25S is formed in the side part of the casing 22. The communicating passage 25S is situated further towards the valve chamber 22S side from a passage-defining wall 25 that extends from the side part of the casing body 23. The communicating passage 25S is open at the top, and is defined by the upper cover 24 and the passage-defining wall 25.

A first pipe 26 projects downward on the diagonal at the side of the passage-defining wall 25. A pipe passage 26a is formed inside the first pipe 26; this pipe passage 26a connects at a first end thereof to the fuel tank FT interior via the communicating passage 25S, the upper chamber 24S, the connecting passage 23b, and the valve chamber 22S, and connects at its other end to the canister side via the tube T1 (FIG. 1). A second pipe 27 having a pipe passage 27a that is parallel to the first pipe 26 projects out below the first pipe 26. The second pipe 27 is situated at the same location in the circumferential direction as the first pipe 26 and parallel therewith in the vertical direction; it connects via the tube T2 to the other fuel cutoff valve 20A that is disposed inside the fuel tank.

The base cover 28 includes a base cover body 28a of circular disk shape; a communicating hole 28b formed in the base cover body 28a; a spring support part 28c defined by the upper face of the base cover body 28a; a first engaging portion 28d; and a engaging portion 28e. As shown in FIG. 4, the first engaging portion 28d is composed of upwardly-projecting hooks formed at two locations, and is designed to attach the base cover 28 to the casing body 23 by fastening together with a valve engaged portion 23e that is composed of a shoulder part that has been formed on the side wall 23c of the casing body 23. The second fastener part 28e fastens together with a support-side fastened part 15e that is composed of a through-hole in the housing part 15, thereby securing the fuel cutoff valve 20 to the housing part 15.

The float mechanism 30 is provided with a float body 31 that is housed in the valve chamber 22 and that has a valve part 32 of generally conical shape projecting up from the top. The valve part 32 is designed to alternately open and close off the connecting passage 23b through rise and fall of the float body 31. The spring 34 is supported by the spring support part 28c, and urges the float mechanism 30 upward.

As shown in FIG. 3, owing to the design of the fuel cutoff valve 20, fuel vapors which have collected at the top of the fuel tank interior as the fuel level in the fuel tank rises will escape through a vent hole 23d in the casing 22, the communicating hole 28b of the base cover 28, the valve chamber 22S, the connecting passage 23b, and the pipe passage 26a, and thence towards the canister through the tube T1. If the fuel level inside the fuel tank FT subsequently reaches a prescribed level due to pitching or rocking of the vehicle, fuel will inflow to the valve chamber 22S through the communicating hole 28b of the base cover 28. The float mechanism 30 will thereby rise through buoyancy, and the valve part 32 of the float mechanism 30 will block off the connecting passage 23b so that the fuel does not leak out towards the canister.

### (4) Attachment Structure of Fuel Cutoff Valve 20 and Support Body

In FIG. 5, once the components of the fuel cutoff valve 20 have been assembled it will be secured to the support body 10. Specifically, the upper cover 24 will be welded to the top of the casing body 23; and after placing the float mechanism 30 and the spring 34 inside, the first engaging portion 28d of the base cover 28 will be fastened together with the valve engaged portion 23e to attach the base cover 28 to the casing body 23. The assembled fuel cutoff valve 20 will then be secured in the housing part 15 by fastening together the engaging portion 28e of the base cover 28 with the support-side fastened part 15e of the mounting plate 15a of the support body 10. Then, after positioning the fuel cutoff valve 20A on the support body in the same way as above, the tube T1 and the tube T2 will be connected to the first and second pipes 26, 27 of the fuel cutoff valve 20; during blow molding, this assembly will be positioned inside the parison, and the mold will be shut so that the upper and lower ends of the parison and the support body 10 weld together.

### (5) Working Effects of the Embodiment

The arrangements set forth in the preceding embodiment afford the following working effects in addition to those mentioned previously.

(5)-1 Since the first and second pipes 26, 27 are situated at the same location in the circumferential direction of the casing 22 and line up in the vertical direction, i.e. they are clustered together in a space to one side of the casing 22, the tubes which are connected to them will likewise be centralized, thus requiring less space inside the tank as compared with the constitute where they are arranged in spaces in more than one direction of the fuel cutoff valve 20 as described in the Related Art. Moreover, by situating the first and second pipes 26, 27 to one side of the casing 22, an outside passage from the fuel tank can be led out from a single location without having to bend the tubes, thus simplifying the layout.
(5)-2 Since the first and second pipes 26, 27 are situated at the same location in the circumferential direction of the casing 22 and line up in the vertical direction, during the injection molding process the first and second pipes 26, 27 can be produced with a single-direction (namely horizontal) split mold, i.e. without the need for a mold design that requires slide molds from several directions, so manufacture will be simpler as well.
(5)-3 The communicating chamber 25S functions as a reservoir for temporarily detaining fuel that has leaked from the tube T2 or the connecting passage 23b, thus preventing fuel from leaking towards the canister through the tube T1.

The present invention is not limited to the embodiment set forth hereinabove, and without departing from the spirit thereof may be embodied in various other modes such as the following modifications, for example.

While the preceding embodiment describes an arrangement whereby the tube T1 is connected to the canister CS and the tube T2 is connected to the other fuel cutoff valve 20A, no particular limitation is imposed thereby, and the reverse tube arrangement, i.e. one in which the top of the communicating chamber connects to the tube of the other fuel cutoff valve and the bottom of the communicating chamber connects to the canister, would be possible to adapt to various placements of the other fuel cutoff valve in the fuel tank or to placement of the canister inside the fuel tank.

While the preceding embodiment describes a fuel cutoff valve that is a rollover valve designed to prevent fuel from leaking out in the event of vehicle rollover, no particular limitation is imposed thereby, and the invention can be implemented in various other kinds of valves such as a full tank check valve designed to restrict the fuel level to a prescribed level during fueling.

The foregoing detailed description of the invention has been provided for the purpose of explaining the principles of the invention and its practical application, thereby enabling others skilled in the art to understand the invention for various embodiments and with various modifications as are suited to the particular use contemplated. The foregoing detailed description is not intended to be exhaustive or to limit the invention to the precise embodiments disclosed. Modifications and equivalents will be apparent to practitioners skilled in this art and are encompassed within the spirit and scope of the appended claims.

What is claimed is:

1. A fuel cutoff valve that is installed in an upper portion of a fuel tank, and opens and closes of a connecting passage that connects the fuel tank interior with outside, the fuel cutoff valve comprising:
a casing that includes a casing body having a valve chamber that connects to the connecting passage, and a communicating chamber that connects the valve chamber to the outside; and
a float mechanism that is housed within the valve chamber and adapted to open and close the connecting passage through rise and fall in accordance with a fuel level inside the fuel tank; wherein
the casing has a first pipe that projects from a side part of the casing and connects the communicating chamber with the outside via a tube, and a second pipe that projects from the side part of the casing and connects the communicating chamber with another valve situated in the fuel tank via a tube, wherein
the first pipe and the second pipe are situated in a mutually parallel arrangement in the vertical direction.

2. The fuel cutoff valve in accordance with claim 1 wherein
the communicating chamber is defined by a side wall of the casing body and a passage-defining wall formed in the side part of the casing, wherein the side wall separates the communicating chamber from the valve chamber.

3. The fuel cutoff valve in accordance with claim 1 wherein
The casing includes a base cover attached a bottom of the casing body, wherein the casing body and the base cover define the valve chamber,
wherein the base cover includes a first engaging portion and adapted to attach the base cover to the casing body through engagement with a valve engaged portion of the casing body; and a second engaging portion adapted to secure the base cover to a member of the fuel tank.

4. The fuel cutoff valve in accordance with claim 1 wherein
the casing includes an upper cover that is attached to an upper portion of the casing body and defines an upper chamber above the valve chamber, wherein the upper chamber connects the communicating chamber and the valve chamber.
